(19) United States
(12) Patent Application Publication
(10) Pub. No.: US 2013/0016219 A1
(43) Pub. Date: Jan. 17, 2013

(54) CAMERA ARRANGEMENT FOR A VEHICLE

(71) Applicants: Martin Hahner, Sindelfingen (DE); Juergen Moczygemba, Reutlingen (DE); Roland Scheurenbrand, Gaeufelden (DE); Guenther Weikert, Aidlingen (DE)

(72) Inventors: Martin Hahner, Sindelfingen (DE); Juergen Moczygemba, Reutlingen (DE); Roland Scheurenbrand, Gaeufelden (DE); Guenther Weikert, Aidlingen (DE)

(73) Assignee: DAIMLER AG, Stuttgart (DE)

(21) Appl. No.: 13/637,689

(22) PCT Filed: Mar. 8, 2011
(86) PCT No.: PCT/EP2011/001117

§ 371 Date: Sep. 27, 2012

(30) Foreign Application Priority Data
Mar. 30, 2010 (DE) 10 2010 013 338.8

(51) Int. Cl. H04N 7/18

(52) U.S. Cl. 348/148; 348/E07.085

(57) ABSTRACT

A camera arrangement (1) for a vehicle, with at least one camera (1.1) with a protective cover (1.2), wherein the camera (1.1) can be pivoted about a pivot axis (X) between a starting position (A) and an operating position (B). According to the invention the pivot axis (X) is arranged so that the camera arrangement (1) can be pivoted exclusively outwards.

The invention relates to a camera arrangement for a vehicle, comprising at least one camera with a protective cover, wherein the camera can be pivoted about a pivot axis between a starting position and an operating position.

EP 1 529 688 B1 discloses a camera arrangement for vehicles with a camera unit for image capture. The camera unit is arranged in a non-active position so that it is substantially inaccessible from externally behind a pivotable protective element for protection from soiling and/or moisture. The camera unit is arranged on the protective element, whereby this is pivotable and the protective element with the camera unit arranged thereon can be pivoted from the position concealing the camera unit, in which the camera is found in the non-active position, into a position, in which the camera is in the active position for image capture. The protective element is configured as a protective cover which, in the position concealing the camera, at least almost completely closes an opening in a vehicle outer shell. A pivot axis is arranged horizontally and as close as possible to the centre line of the protective element on the rear side thereof.

It is the object of the invention to indicate a camera arrangement for a vehicle which has been improved having regard to the prior art.

This object is achieved according to the invention through the features indicated in claim 1. Advantageous developments of the invention are the subject matter of the sub-claims.

A camera arrangement for a vehicle comprises at least one camera which comprises a protective cover, wherein the camera can be pivoted about a pivot axis between a starting position and an operating position. According to the invention the pivot axis is arranged in such a way that the camera arrangement can be pivoted exclusively outwards.

Through the arrangement of the pivot axis according to the invention, the camera with the protective cover can be fully pivoted outwards, thus away from the vehicle, i.e. no partial area of the camera and the cover is pivoted inwards during the pivoting action from the starting position into the operating position. An incorporation depth of a required construction space for arranging the camera arrangement can thereby be advantageously reduced.

In addition the camera arrangement is protected by means of the protective cover at least in the starting position from the effects of the weather, such as for example soiling and/or water.

Exemplary embodiments of the invention are explained in greater detail below with the aid of the drawing, in which:

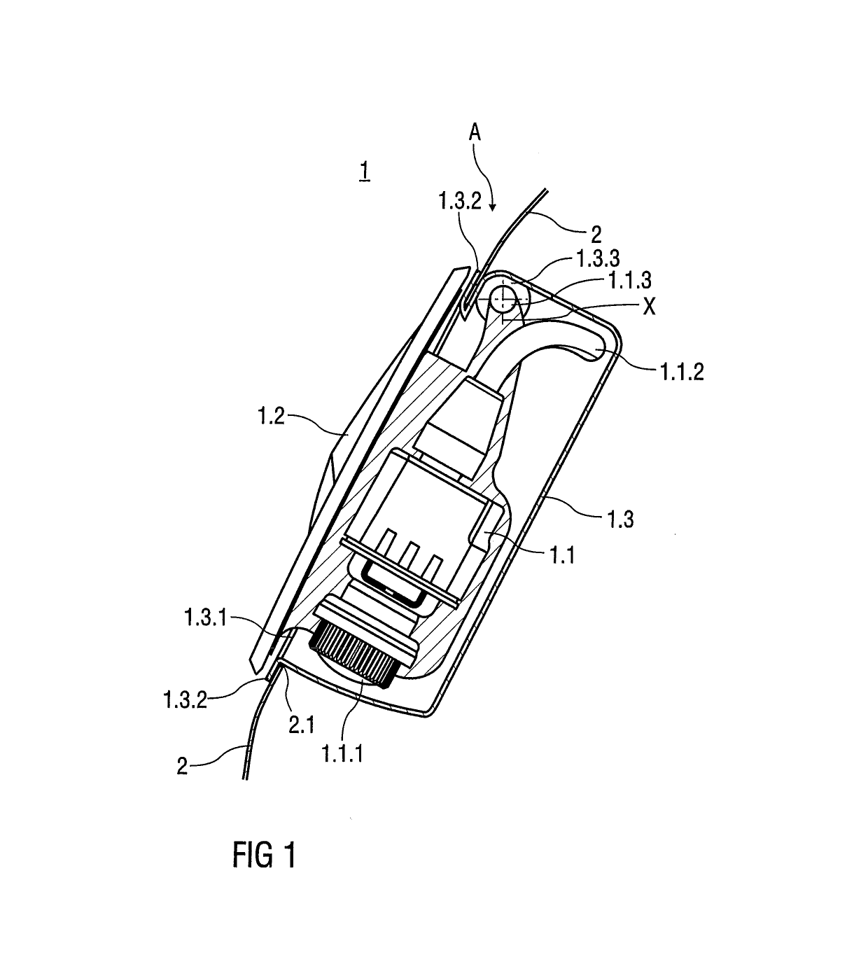

FIG. 1 shows, schematically, a camera arrangement for a vehicle in a starting position, and

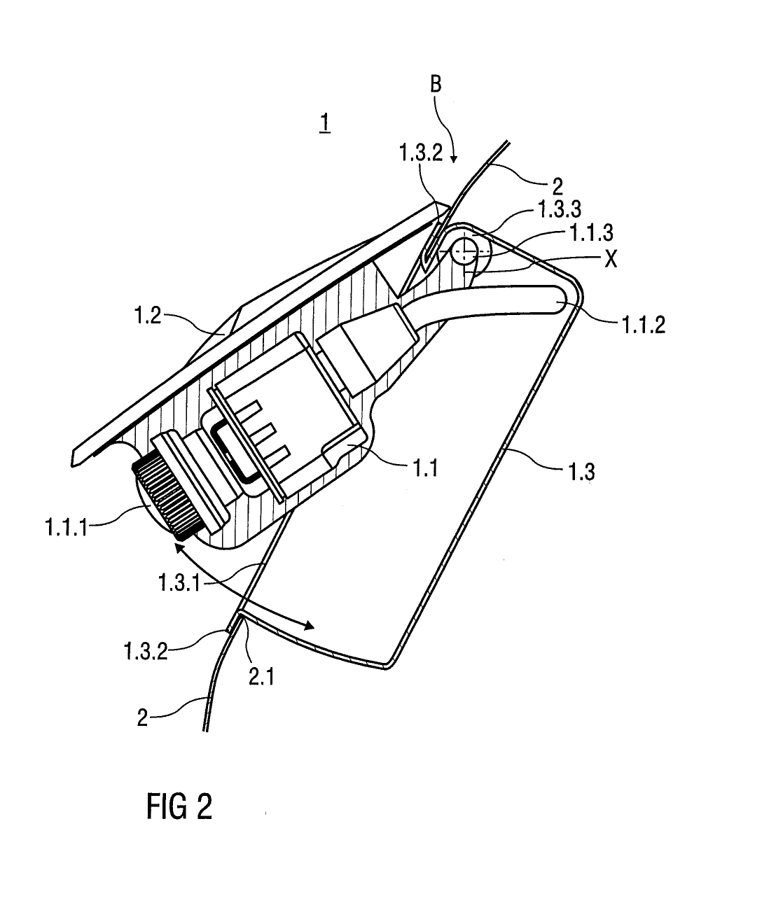

FIG. 2 shows, schematically, a camera arrangement for a vehicle in an operating position.

Corresponding parts are provided in all the figures with the same reference numerals.

FIG. 1 shows a camera arrangement 1 for a vehicle (not shown in further detail) with at least one camera 1.1 in a starting position A. The camera 1.1 is a reversing camera of the vehicle, wherein the camera 1.1 is arranged on the rear region thereof.

In the starting position A, the camera 1.1 is arranged in a housing 1.3 which is arranged in an opening 2.1 of a body panel 2 of the vehicle. A housing opening 1.3.1 can be covered by means of a protective cover 1.2 which is arranged on the camera 1.1, wherein the protective cover 1.2 is shown in the present exemplary embodiment according to FIG. 1 in a state in which it is not completely closed. The camera 1.1 can be pivoted with the protective cover 1.2 arranged on said camera 1.1 from the starting position A about a pivot axis X into an operating position B shown in FIG. 2. By means of the protective cover 1.2 the camera 1.1. is advantageously extensively protected at least in the starting position A against soiling and/or wet.

In the present exemplary embodiment according to FIG. 1, a lens 1.1.1 of the camera 1.1 is arranged pointing downwards, wherein the longitudinal axis of the camera 1.1 extends substantially parallel to the body panel 2 of the vehicle in the starting position A. A power supply line 1.1.2 of the camera 1.1 is also arranged in the housing 1.3, wherein the power supply line 1.1.2 is guided on the upper side of the housing 1.3, on which the pivot axis X is also arranged, through said housing 1.3.

The housing 1.3 is arranged in the body panel 2 which forms the outer shell of the vehicle, wherein the body panel 2 comprises the above-described opening 2.1. The dimensions of the opening 2.1 thereby correspond to a width and a height of the housing 1.3. The housing 1.3 is arranged in the opening 2.1 of the body panel 2 in such a way that it is sealed against environmental influences such as e.g. rain. For this purpose a collar-like edge region 1.3.2 is formed on the housing 1.3 which surrounds the opening 2.1 in the body panel 2, whereby the opening 2.1 is sealed in particular against penetrating wet and/or soiling. Alternatively it is possible to arrange for example a sealing element between the collar-like edge region 1.3.2 and the body panel 2.

The housing 1.3 is composed of a plastic but can alternatively also be composed of another suitable material.

In the starting position A of the camera 1.1 the protective cover 1.2 conceals the housing opening 1.3.1, wherein the protective cover 1.2 projects in the closed state, i.e. in the starting position A of the camera 1.1, away from the body panel 2 by a thickness of the protective cover 1.2. The outer side of the protective cover 1.2 is provided with a trade mark of the vehicle manufacturer.

In the starting position A the protective cover 1.2 lies on the edge region 1.3.2 of the housing 1.3, completely surrounding it and thus in a shape-locking manner, wherein no additional sealing elements are arranged between the collar-form edge region 1.3.2 and the protective cover 1.2. The camera 1.1 arranged in the housing 1.3 is thus protected in the starting position A from the entry of water and/or soiling. Alternatively, a seal can be provided which is either fixed to the camera 1.1 to on the protective cover 12.

The protective cover 1.2 is releasably fixed to the camera 1.1 in a force-locking and shape-locking way. For this purpose the protective cover 1.2 is screwed by means of connecting elements, not shown, in the form of screws to the camera 1.1. The camera 1.1 and the protective cover 1.2 are thus brought together as one component. Alternatively or additionally, the protective cover 1.2 can also be fixed by means of a latching connection on the camera 1.1.

Due to the fact that the protective cover 1.2 is releasably fixed to the camera 1.1, said protective cover 1.2 can be removed from the camera 1.1, whereby it is possible to make the camera 1.1 accessible and to remove it from the housing 1.3 without requiring significant resources. It is also possible to remove the camera 1.1 together with the housing 1.3 from the opening 2.1 of the body panel 2.

In order to reduce the incorporation depth of the camera arrangement 1, the pivot axis X for pivoting the camera 1.1 is arranged according to the invention on the side lying opposite the lens 1.1.1 of the camera 1.1. In this connection a shaft 1.1.3 is horizontally arranged on the camera 1.1 which is mounted so as to be rotatable in bearing supports 1.3.3 which are arranged in the housing 1.3. At one end of the shaft 1.1.3, which defines the pivot axis X, an electric drive unit (not shown in greater detail) is arranged, by means of which the shaft 1.1.3 can be rotated.

The shaft 1.3.3 is fixedly arranged on the camera 1.1 so that the camera pivots with the protective cover 1.2 fixed to it upon rotation of the shaft 1.3.3.

The camera 1.1 can be pivoted by means of the electric drive unit upon engagement of a reverse gear automatically into the operating position B. Alternatively or additionally, an operating element (not shown in further detail) can be provided, upon activation of which the camera 1.1 can be pivoted into the operating position B and back into the starting position A.

FIG. 2 shows the camera arrangement 1 in the operating position B. The camera 1.1 is thereby pivoted in the operating position B with respect to the longitudinal axis by approximately 30° relative to the starting position A. Through the pivot movement of the camera 1.1, the protective cover 1.2 pivots so that the housing opening 1.3.1 is no longer concealed. The camera 1.1 pivots completely out of the housing 1.3, whereby likewise no partial region of the camera 1.1 and the protective cover 1.2 is pivoted into the housing 1.3 upon pivoting from the starting position A into the operating position B.

In the operating position B, an image capture region of the camera 1.1 lies outside of the body panel 2. It is thereby particularly advantageous that a shock absorber unit (not shown in greater detail) arranged in the rear region of the vehicle can be captured.

Furthermore it is provided that pivoting of the camera 1.1 with the protective cover 1.2 fixed thereto from the starting position A into the operating position B is limited. The electric drive unit is automatically deactivated if an electrical energy of the electric drive unit exceeds a threshold when the operating position B is reached. If the camera 1.1. with the protective cover 12 arranged on it cannot be pivoted due to weather influences such as e.g. ice, the electric drive unit is also automatically deactivated. Damage to the camera arrangement 1 and the electric drive unit is thereby extensively avoided.

Alternatively or additionally, it can be provided that the electric drive unit can be controlled in such a way that a path of the pivot movement can be predefined, i.e. an angle between the starting position A and the operating position B of the camera 1.1 can be variably set.

According to an advantageous embodiment of the camera arrangement 1, which is not shown in the exemplary embodiment according to FIGS. 1 and 2, the power supply line 1.1.2 extends through the shaft 1.1.3 which defines the pivot axis X and/or through a bearing support 1.3.3.

According to a further embodiment of the camera arrangement 1 the pivot axis X can also be arranged in the region of the protective cover 1.2 so that the incorporation depth of the camera arrangement 1 is reduced.

1. A camera arrangement (1) for a vehicle, comprising at least one camera (1.1) with a protective cover (1.2), wherein the camera (1.1) can be pivoted about a pivot axis (X) between a starting position (A) and an operating position (B), wherein the pivot axis (X) is arranged in such a way that the camera arrangement (1) can be pivoted exclusively outwards.

2. The camera arrangement (1) according to claim 1, wherein the pivot axis (X) is arranged on the camera (1.1).

3. The camera arrangement (1) according to claim 2, wherein the camera has a lens, and wherein the pivot axis (X) is arranged on a side of the camera lying opposite the lens (1.1.1) of the camera (1.1).

4. The camera arrangement (1) according to one of the claim 1, wherein the camera (1.1) wherein in the starting position (A) is arranged in a housing (1.3).

5. The camera arrangement (1) according to claim 4, wherein the camera (1.1) is mounted so that it can be pivoted in the housing (1.3).

6. The camera arrangement (1) according to claim 3, wherein at least one seal for sealing the protective cover (1.2) with respect to the housing (1.3) in the starting position (A) is formed on the housing (1.3) and/or the protective cover (1.2).
